(19) United States
(12) Patent Application Publication
(10) Pub. No.: US 2022/0158865 A1
(43) Pub. Date: May 19, 2022

(54) ASYNCHRONOUS COMMUNICATION IN MULTIPLEXED TOPOLOGIES

(71) Applicant: Intel Corporation, Santa Clara, CA (US)

(72) Inventors: Richard Marian THOMAIYAR, Trichy (IN); Janusz JURSKI, Beaverton, OR (US); Myron LOEWEN, Berthoud, CO (US); Zbigniew LUKWINSKI, Gdansk (PL)

(21) Appl. No.: 17/665,439

(22) Filed: Feb. 4, 2022

Related U.S. Application Data
(60) Provisional application No. 63/278,026, filed on Nov. 10, 2021.

(51) Int. Cl. H04L 12/403; H04L 12/40; H04L 12/12

(52) U.S. Cl. CPC H04L 12/403; H04L 12/12; H04L 12/40039

(57) ABSTRACT

Examples described herein relate to circuitry that is to manage communications to and from a manageability controller. In some examples, during communications on a first port, circuitry generates a bus busy condition for one or more other ports to block transactions from one or more devices.

### RELATED APPLICATION

The present application claims the benefit of priority of U.S. Provisional application Ser. No. 63/278,026, filed Nov. 10, 2021. The contents of that application is incorporated herein in its entirety.

### BACKGROUND

PCI-SIG specifications define a manageability controller (e.g., Baseboard Management Controller (BMC)) as connecting to Peripheral Component Interconnect express (PCIe) endpoint devices through System Management Bus (SMBus), Inter-Integrated Circuit (I2C) protocol interface, or Mobile Industry Processor Interface (MIPI) Alliance I3C standard. An SMBus multiplexer (mux) device, controlled by a BMC, can be used to support multiple PCIe slots and prevent direct communication between multiple PCIe endpoint devices. The multiplexer can provide isolation between PCIe devices and a target device, reduce address conflicts, or prevent a single device from locking an entire bus. In a server, many endpoint devices (e.g., PCIe slots, cables, etc.) can be connected to the BMC. Using the SMBus multiplexer device, secured isolation can be provided across devices and communication capabilities can be provided to handle protocols where an endpoint device may initiate asynchronous request messages.

FIG. 1 depicts an SMBus multiplexer for PCIe slot connection. A BMC can be connected to one of the SMBus downstream ports to communicate with an endpoint device. Other devices can be unable to communicate with the BMC and the BMC cannot receive data from the other devices. The BMC can enable a selected port to send or receive data from the endpoint device. For example, communications between BMC and devices connected to PCIe Slots A, C, and X result in negative acknowledgement (NAK or NACK), whereas communications with the device connected to slot B permit data to be transmitted and received with the BMC.

FIG. 2 depicts an example operation of an SMBus multiplexer to PCIe slot connection for manageability traffic. The BMC can communicate with only one device at a time and other devices are not able to communicate with the mux when the BMC communicates with the one device. To transact data to and from the device connected to a PCIe slot, the downstream multiplexer port is enabled. For example, port 0 can be selected to allow the BMC to communicate with the device coupled to PCIe slot 0. During connection of the BMC to the device coupled to PCIe slot 0, the device coupled to PCIe slot X attempts to communicate with the BMC but does not receive a confirmation of a response (e.g., acknowledgement or ACK) resulting in asynchronous failed request packets. The device coupled to PCIe slot X interprets the lack of received ACK as a NACK and stops further attempts to communicate with the BMC after reaching a maximum number of retries without receiving an ACK.

For communications with a device coupled to PCIe slot 0, the BMC holds the connection through port 0 until a response is received or a timeout occurs (when expecting response). After a response is received, the BMC can change the active port to port X to communicate with the device coupled to PCIe slot X. During connection of BMC to the device coupled to PCIe slot X, the device coupled to PCIe slot 0 attempts to communicate with the BMC but does not receive a confirmation of a response (e.g., acknowledgement or ACK). The device coupled to PCIe slot 0 interprets the lack of received ACK as a NACK and stops further attempts to communicate with the BMC after reaching a maximum number of retries without receiving an ACK.

### BRIEF DESCRIPTION OF THE DRAWINGS

FIG. 1 depicts an example system.

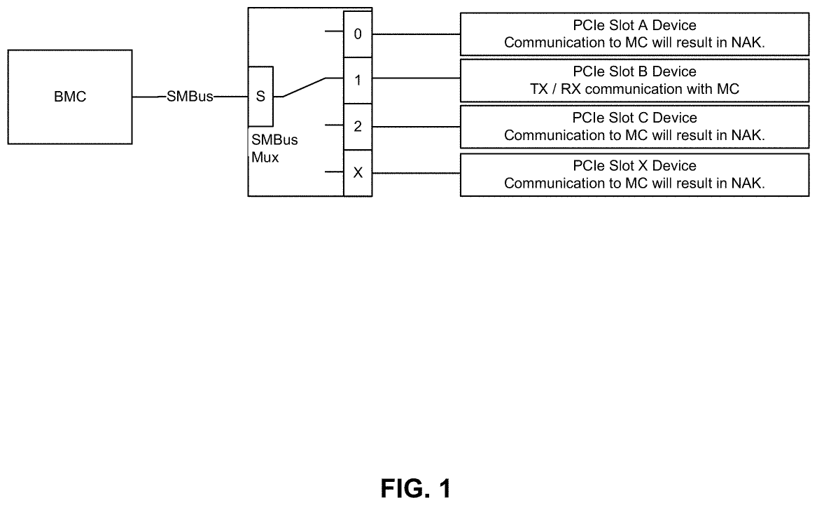

FIG. 2 depicts an example of operations.

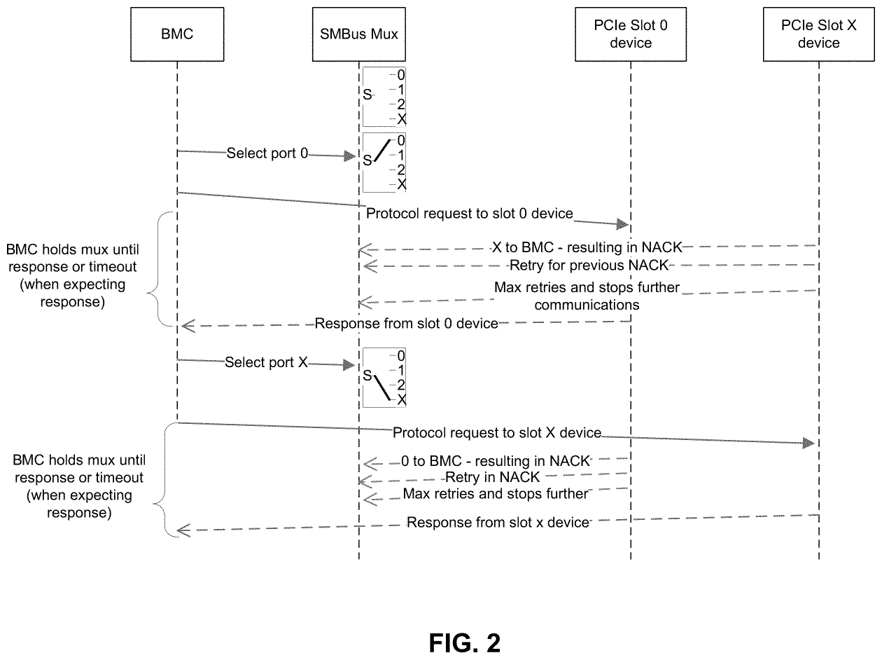

FIG. 3 depicts an example system.

FIG. 4 depicts an example of operations.

FIG. 5 depicts an example of operations.

FIG. 6 depicts an example process.

FIG. 7 depicts an example computing system.

FIG. 8 depicts an example system.

### DETAILED DESCRIPTION

When devices transmit messages or signals to closed ports, energy can be consumed by communications that do not arrive at the target and data loss can potentially result. Examples described herein can reduce power consumption and use hub or multiplexer to connect only to the port(s) connected to an endpoint device with data that is ready to be sent. In some examples, manageability firmware can configure a multiplexer to open or enable a port when expecting a response from an endpoint device such as an SMBus request from the endpoint or a response in terms of Intelligent Platform Management Bus (IPMB) Communications Protocol/Management Component Transport Protocol (MCTP) protocol. The hub or multiplexer can utilize a buffer to store one or more transactions received from endpoint devices received at closed ports for communication to a manageability controller or other device.

The hub, multiplexer device, or an on-circuit board component (e.g., circuitry connected to a circuit board) can include circuitry to generate a bus busy condition on a port when the device or component is switched to another port or the buffer is full. For example, System Management Bus (SMBus) Specification version 2.0 (2000) defines data lanes and clock lanes. In some examples, a data lane can be held low to indicate the bus is busy. Circuitry in the mux or hub or additional on-board component can detect whether a device attempts to transmit when a manageability controller cannot receive data through a port and can cause the endpoint device to lose SMBus arbitration. When a device attempts to send data to a port that is not open, the device loses arbitration by a collision occurring from a data line being held low (e.g., for a duration or length of an address and ACK). The endpoint device may wait until the bus becomes available (not busy) before transmitting data. A status indicator in a register or notification registers may indicate to the manageability controller which endpoints are ready to communicate, or have attempted to communicate, with the manageability controller and the manageability controller may connect to one or more devices that are ready to communicate with the manageability controller.

When the manageability controller is ready to receive data (e.g., when MUX is switched to receive communications from the device or buffer space becomes available), the busy condition may be disabled to allow the endpoint to transmit data to the manageability controller.

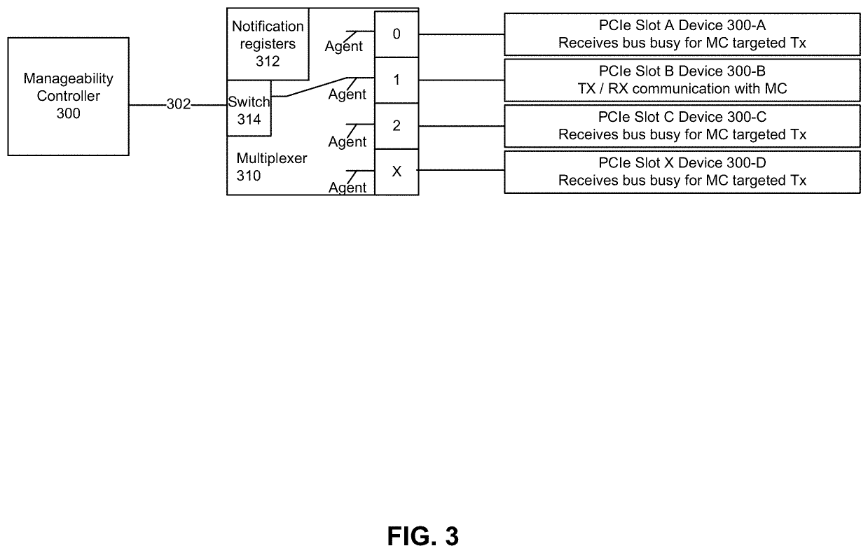

FIG. 3 depicts an example system. The system can indicate a bus is busy to a device that attempts to transmit to the manageability controller while the manageability controller communicates with another device using a different port. The system can utilize a notification register to identify which device(s) attempt to transmit to the manageability controller but are blocked from transmitting communications due to one or more closed or busy ports. In some examples, manageability controller (MC) 300 can include a baseboard management controller (BMC). A BMC can perform tasks on behalf of a data center administrator such as power cycling a server, monitoring hardware failures, monitoring device temperature, monitoring cooling fan speeds, monitoring power status, monitoring operating system (OS) status, and so forth. MC 300 can monitor sensors and can send alerts to a system administrator of parameter abnormalities (e.g., parameters not within pre-set limits). Other devices can be used instead of an MC, including a virtual machine, container, microservice, process, software, processor, accelerator, network interface device or other circuitry.

Connection 302 can include communication circuitry and utilize protocols to provide signal and message communication between MC 300 and multiplexer 310. In some examples, connection 302 can operate in a manner consistent with SMBus, I2C, or I3C, although other protocols can be utilized. Multiplexer 310 can utilize switch 314 to communicatively couple MC 300 with one of ports 0, 1, 2, or X. Multiplexer 310 can provide a hub for SMBus or I3C communications between MC 300 and devices 300-A, 300-B, 300-C, or 300-D. In some examples, devices 300-A, 300-B, 300-C, or 300-D includes one or more of: an accelerator, network interface device, processor, or other circuitry. Devices can be coupled to multiplexer 310 using a device interface such as Peripheral Component Interconnect express (PCIe) or Compute Express Link (CXL). Multiplexer 310 can provide a bus busy signal to device that communicate to a disconnected port. PCIe SMBus is described, for example, in System Management Bus (SMBus) Specification Version 2.0, Aug. 3, 2000, as well as earlier versions, later versions, variations, and derivatives thereof. Without loss of generality, examples use PCIe SMbus architecture as the example topology, however examples can be applied in other topologies or architectures that use a multiplexer or circuitry to forward communications.

Switch 314, or circuitry connected on-board to multiplexer 310, can detect whether a device attempts to transmit to multiplexer 310 when MC 300 cannot receive a communication from such device (e.g., a port is not open or available to receive a communication from such device) and can cause the device to lose arbitration by indicating the bus is busy. A bus busy generation can be performed by multiple technologies such as keeping SMBDATA line low or causing a general-purpose input/output (GPIO) pin to be in a low state. For example, switch 314, or circuitry connected on-board to multiplexer 310, can cause the device to lose SMBus arbitration by lowering the data line for, e.g., 256 bytes of transaction, followed by a Stop termination to simulate Bus busy generation when the device transmits to MC 300. In some examples, the circuitry connected on-board to multiplexer 310 can be implemented as a field programmable gate array (FPGA) and/or other circuitry.

Bus busy generation can occur in response to a transaction from a device targeted for a BMC address associated with MC 300. As described herein, multiplexer 310, or the circuitry connected on-board, can generate a Bus busy state continuously while another port is utilized, cause a bus busy state by one or more start and stop conditions, or in response to receipt of a SMBus Start transaction. In response to the bus busy condition, an endpoint device may fail in arbitration and may wait for a bus free condition to request to transmit data to MC 300.

For continuous application of bus busy state, Management Component Transport Protocol (MCTP) SMBus binding specification (e.g., Management Component Transport Protocol (MCTP) SMBus/I2C Transport Binding Specification, Version 1.2.0 (2020), as well as earlier versions, later versions, variations, and derivatives thereof) allows keeping SMBDATA line low condition to last for 2 to 5 seconds, which may be sufficiently long for manageability controller 300 to switch to other connected devices.

Generating a bus busy in response to identification of a Start transaction on the bus can utilize less power to merely generate a bus busy condition when a data transfer is attempted by an endpoint device.

Notification registers 312 can indicate if a device among devices 300-A to 300-D attempts to transmit to a specific port (e.g., port 0 to X, where X is an integer) but received a bus busy condition or was otherwise not able to transmit or receive from a port of multiplexer 310. For example, a device that loses arbitration on a port can be identified as a device that attempts to transmit to a specific port. Notification registers 312 can identify a port number that indicates whether a transmission was attempted to a port. For example, notification registers 312 can be implemented as a bitmap that indicates whether a transmission was attempted on a port. For example, Table 1 indicates an example bitmap that corresponds to ports 0 to X and a 1 indicates a transmission was attempted on the port and a 0 indicates a transmission was not attempted on the port. However, different data structures and values can be used to indicate attempted transmission or no attempted transmission.

TABLE 1

| Port 0 | Port 1 | Port 2 | Port X |
|---|---|---|---|
| 0/1 | 0/1 | 0/1 | 0/1 |

MC 300 can check notification registers 312 to determine which ports or endpoints have data to transmit to MC 300. MC 300 can switch multiplexer 310 to allow communication on a port with an endpoint that attempted communication as identified in notification registers 312, in a round robin manner or a priority of ports can be followed. MC 300 can cause multiplexer 310 to select a different active and open port to correspond to a device that is to be connected to MC 300 next. Connecting to a port or device that was identified as attempting a connection can reduce latency of communication from such device. Notification registers 312 can be implemented as registers, a region of memory, or other device.

Examples can be used at least for Management Component Transport Protocol (MCTP) protocol, asynchronous MCTP message types such as Platform Level Data Model (PLDM), telemetry streaming, etc.

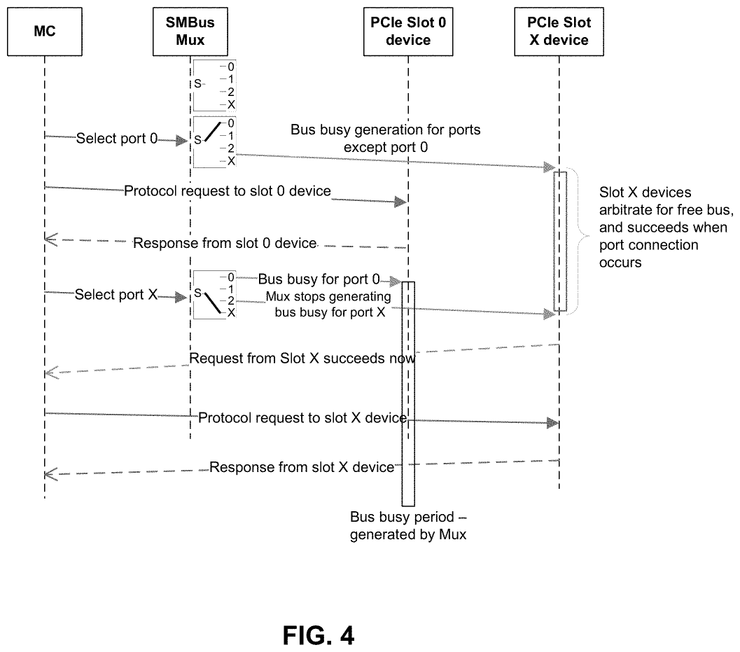

FIG. 4 depicts an example of operations where a multiplexer generates bus busy for MC targeted address. During initialization by a driver, an MC receiver address can be configured in an agent (e.g., SMBus mux (or other device)). The agent may analyze traffic generated by disconnected endpoint devices (e.g., devices connected to inoperative ports). The agent may allow traffic between devices on the bus as long as the transactions are not targeting the MC. The agent may detect when the endpoint device initiates START on the bus followed by the MC address and can simulate an ACK followed by keeping the data line low for an amount of time or number of bytes (e.g., next 256 bytes). The endpoint device may identify the communication from the agent as multi-primary arbitration loss and may wait for bus free condition. The endpoint device may not treat this condition as failed transaction and may not increment retry counters.

Description of a particular operation in FIG. 4 is described next. MC selects port 0 as an open port through which a connected device can transmit and receive communications. The multiplexer generates a bus busy for port X while port 0 for slot 0 is selected as a port that permits communications with the MC. The device coupled to slot X waits for a bus free condition before attempting to communicate with MC again. The MC deselects slot 0 for communication with MC and selects slot X for communications with the MC. The MC stops generating a bus busy for port X and the device communication via slot X and port X can communicate with the MC. The multiplexer generates a bus busy for port 0 while port X for slot X is selected as a port that permits communications with the MC.

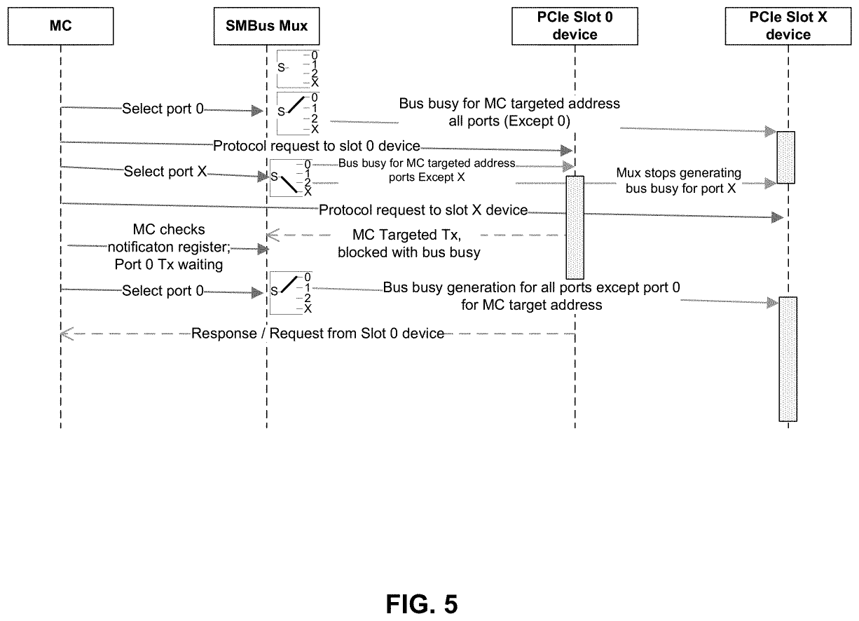

FIG. 5 depicts an example of operations using a notification register to identify devices, slots, and/or ports that unsuccessfully attempted to communicate with the MC. An agent (e.g., SMBus Mux or device) may maintain notification register to log requests by a device that attempted to communicate with MC using a specific port during a busy state. MC may check the notification register to determine which endpoints have data to transmit to the MC. MC may switch the mux to permit communication with one of the endpoints identified in the notification register after or when communication with a current endpoint is configured.

Description of a particular operation in FIG. 5 is described next. MC selects port 0 as an open port through which a connected device can transmit and receive communications. The multiplexer generates a bus busy for port X while port 0 for slot 0 is selected as a port that permits communications with the MC. The MC deselects slot 0 for communication with MC and selects slot X for communications with the MC. The MC stops generating a bus busy for port X and the device coupled to slot X and port X can communicate with the MC. The multiplexer generates a bus busy for port 0 while port X for slot X is selected as a port that permits communications with the MC. During communications using slot X, a device coupled to slot 0 attempted communication with MC but was blocked. Notification register identifies that a communication was attempted on slot 0. MC reads notification register and determines that a transmission on port 0 is waiting. The MC deselects slot X for communication with MC and, based on the indication in the notification registers that a device attempted communication through port 0, selects port 0 for slot 0 for communications with the MC.

The MC can wait for a response from the endpoint device before switching to another device to provide sequential execution and asynchronous responses. For a command, such as Get MCTP Version, the response preparation can take about 10 milliseconds. For example, for 16 devices connected to the multiplexer and the devices taking 10 milliseconds to prepare the response, the total waiting time can be approximately 160 ms for a single command. With some examples, the MC can send a request to the 16 devices concurrently and not wait for the response in sequence and save approximately 160 ms of the waiting time.

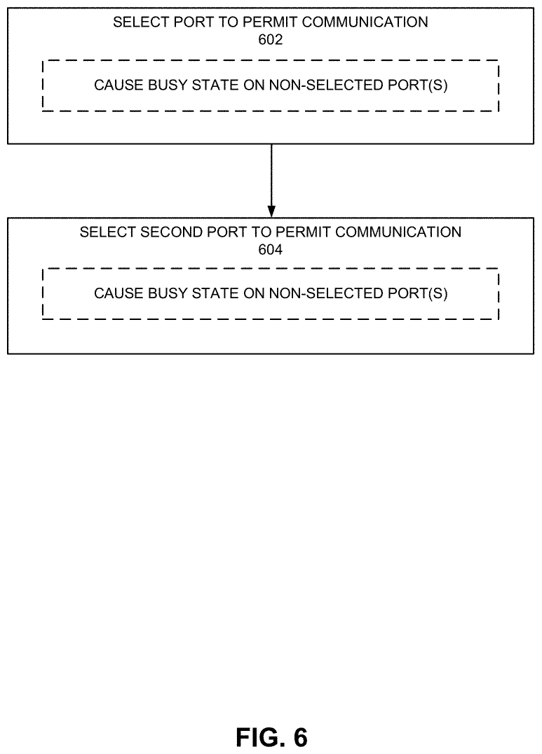

FIG. 6 depicts an example process. The process can be used to configure an intermediary device to permit or not permit communications between a device and a target device. At 602, the intermediary device can be configured to select a port through which communication between the device and target device can occur. In some examples, the intermediary device includes a multiplexer, hub, or circuitry to which one or more devices are coupled using device interfaces using one or more ports and slots. In some examples, the target device includes a BMC or MC. In some examples, the device includes an accelerator, network interface device, processor, or other circuitry. The intermediary device can assert a busy state on non-selected ports continuously while a selected port is utilized, based on one or more start and stop conditions, or in response to receipt of a SMBus Start transaction.

At 604, based on selection of a second device to communicate with the target device, the intermediary device can permit communication through a second port connected to the second device. In some examples, the intermediary device can access a notification register that indicates which device attempted a communication with the intermediary device on a non-selected port in order to select the non-selected port to be selected to permit communications with the device attempted a communication with the intermediary device on the non-selected port. The intermediary device can assert a busy state on non-selected ports continuously while a selected port is utilized.

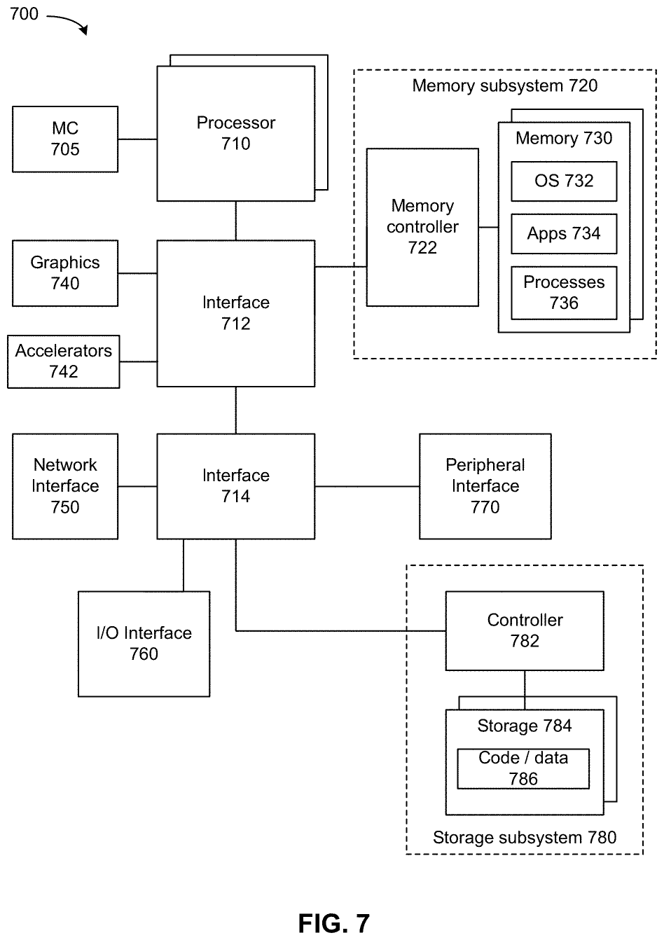

FIG. 7 depicts a system. Components of system 700 (e.g., processor 710, network interface 750, and so forth) can generate bus busy conditions to downstream devices that are not connected to active port(s) to reduce packet losses and communications from downstream devices not connected to active port(s), as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

MC 705 can be configured to generate bus busy conditions to downstream devices that are not connected to active port(s) to reduce packet losses and communications from downstream devices not connected to active port(s), as described herein.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, a driver can enable or disable generation of bus busy conditions to downstream devices that are not connected to active port(s) to reduce packet losses and communications from downstream devices not connected to active port(s), as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720. In some examples, network interface 750 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

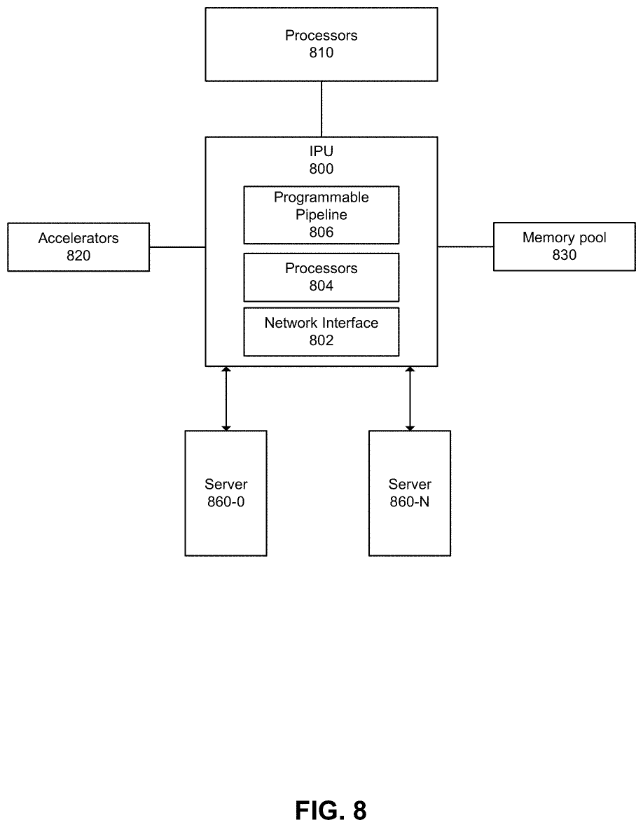

FIG. 8 depicts an example system. In this system, IPU 800 manages performance of one or more processes using one or more of processors 810, accelerators 820, memory pool 830, or servers 840-0 to 840-N, where N is an integer of 1 or more. In some examples, processors 804 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. In some examples, IPU 800 can utilize embodiments described herein to manage communications with manageability controller devices in IPU 800 or other devices connected to IPU 800.

Single Root I/O Virtualization (SR-IOV) and Sharing specification, version 1.1, published Jan. 20, 2010 specifies hardware-assisted performance input/output (I/O) virtualization and sharing of devices. Intel® Scalable I/O Virtualization (SIOV) permits configuration of a device to group its resources into multiple isolated Assignable Device Interfaces (ADIs). Direct Memory Access (DMA) transfers from/to each ADI are tagged with a unique Process Address Space identifier (PASID) number. Unlike the device partitioning approach of SR-IOV to create multiple virtual functions (VFs) on a physical function (PF), SIOV enables software to flexibly compose virtual devices utilizing the hardware-assists for device sharing at finer granularity. An example technical specification for SIOV is Intel® Scalable I/O Virtualization Technical Specification, revision 1.0, June 2018, as well as earlier versions, later versions, and variations thereof. Various examples herein can be utilized to manage communications by VMs, containers, microservices, or other processes with SR-IOV or SIOV accessible devices. Various examples herein can be utilized to manage communications by SR-IOV or SIOV accessible devices with VMs, containers, microservices, or other processes.

Partitioned Global Address Space (PGAS) is a programming model utilized in distributed memory systems whose resources are shared by multiple processors. Various examples herein can be utilized to manage communications by processors to memory devices that are utilized in a PGAS consistent system. Various examples herein can be utilized to manage communications by memory devices that are utilized in a PGAS consistent system to processors.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”'

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes an apparatus comprising: circuitry to: during communications on a first port, generate a bus busy condition for one or more other ports to block transactions from one or more devices, wherein the communications are transmitted to or received from a manageability controller.

Example 2 includes one or more examples, wherein the generate a bus busy condition comprises cause at least one SMBDATA line to be in a low state.

Example 3 includes one or more examples, wherein the generate a bus busy condition comprises cause at least one general-purpose input/output (GPIO) pin to be in a low state.

Example 4 includes one or more examples, wherein the generate a bus busy condition comprises generate a bus busy condition based on receipt of a START transaction from the one or more other ports.

Example 5 includes one or more examples, wherein the circuitry comprises one or more of: a multiplexer, a hub, or circuitry connected to a circuit board.

Example 6 includes one or more examples, wherein the communications are transmitted to or received from a manageability controller.

Example 7 includes one or more examples, comprising: circuitry to select a second port among the one or more other ports to permit communications based on an indication that a device attempted communication through the second port during the bus busy condition.

Example 8 includes one or more examples, and includes one or more devices coupled to the circuitry via one or more device interfaces, wherein the one or more devices comprise one or more of: an accelerator, a network interface device, or a processor.

Example 9 includes one or more examples, and includes at least one server comprising a manageability controller communicatively coupled to the circuitry, wherein the circuitry is control communication with the manageability controller.

Example 10 includes one or more examples, and includes a computer-readable medium, comprising instructions stored thereon, that if executed by one or more processors, cause the one or more processors to: during communications on a first port, generate a bus busy condition for one or more other ports to block transactions from one or more devices, wherein the communications are transmitted to or received from a manageability controller.

Example 11 includes one or more examples, wherein the generate a bus busy condition comprises cause at least one SMBDATA line to be in a low state.

Example 12 includes one or more examples, wherein the generate a bus busy condition comprises cause at least one general-purpose input/output (GPIO) pin to be in a low state.

Example 13 includes one or more examples, wherein the generate a bus busy condition comprises generate a bus busy condition based on receipt of a START transaction from the one or more other ports.

Example 14 includes one or more examples, wherein the communications are transmitted to or received from a manageability controller.

Example 15 includes one or more examples, and includes instructions stored thereon, that if executed by one or more processors, cause the one or more processors to: select a second port among the one or more other ports to permit communications based on an indication that a device attempted communication through the second port during the bus busy condition.

Example 16 includes one or more examples, and includes a method comprising: in a hub device: during communications on a first port in the hub device, generating a bus busy condition for one or more other ports to block transactions from one or more devices, wherein the communications are transmitted to or received from a manageability controller.

Example 17 includes one or more examples, wherein the generating a bus busy condition comprises cause at least one SMBDATA line to be in a low state.

Example 18 includes one or more examples, wherein the generating a bus busy condition comprises cause at least one general-purpose input/output (GPIO) pin to be in a low state.

Example 19 includes one or more examples, wherein the generating a bus busy condition comprises generate bus busy based on receipt of a START transaction from the one or more other ports.

Example 20 includes one or more examples, wherein the communications are transmitted to or received from a manageability controller.

What is claimed is:

1. An apparatus comprising:
circuitry to:
during communications on a first port, generate a bus busy condition for one or more other ports to block transactions from one or more devices, wherein the communications are transmitted to or received from a manageability controller.

2. The apparatus of claim 1, wherein the generate a bus busy condition comprises cause at least one SMBDATA line to be in a low state.

3. The apparatus of claim 1, wherein the generate a bus busy condition comprises cause at least one general-purpose input/output (GPIO) pin to be in a low state.

4. The apparatus of claim 1, wherein the generate a bus busy condition comprises generate a bus busy condition based on receipt of a START transaction from the one or more other ports.

5. The apparatus of claim 1, wherein the circuitry comprises one or more of: a multiplexer, a hub, or circuitry connected to a circuit board.

6. The apparatus of claim 1, wherein the communications are transmitted to or received from a manageability controller.

7. The apparatus of claim 1, comprising:
circuitry to select a second port among the one or more other ports to permit communications based on an indication that a device attempted communication through the second port during the bus busy condition.

8. The apparatus of claim 1, comprising:
one or more devices coupled to the circuitry via one or more device interfaces, wherein the one or more devices comprise one or more of: an accelerator, a network interface device, or a processor.

9. The apparatus of claim 8, comprising:
at least one server comprising a manageability controller communicatively coupled to the circuitry, wherein the circuitry is control communication with the manageability controller.

10. A computer-readable medium, comprising instructions stored thereon, that if executed by one or more processors, cause the one or more processors to:
during communications on a first port, generate a bus busy condition for one or more other ports to block transactions from one or more devices, wherein the communications are transmitted to or received from a manageability controller.

11. The computer-readable medium of claim 10, wherein the generate a bus busy condition comprises cause at least one SMBDATA line to be in a low state.

12. The computer-readable medium of claim 10, wherein the generate a bus busy condition comprises cause at least one general-purpose input/output (GPIO) pin to be in a low state.

13. The computer-readable medium of claim 10, wherein the generate a bus busy condition comprises generate a bus busy condition based on receipt of a START transaction from the one or more other ports.

14. The computer-readable medium of claim 10, wherein the communications are transmitted to or received from a manageability controller.

15. The computer-readable medium of claim 10, comprising instructions stored thereon, that if executed by one or more processors, cause the one or more processors to:
select a second port among the one or more other ports to permit communications based on an indication that a device attempted communication through the second port during the bus busy condition.

16. A method comprising:
in a hub device:
during communications on a first port in the hub device, generating a bus busy condition for one or more other ports to block transactions from one or more devices, wherein the communications are transmitted to or received from a manageability controller.

17. The method of claim 16, wherein the generating a bus busy condition comprises cause at least one SMBDATA line to be in a low state.

18. The method of claim 16, wherein the generating a bus busy condition comprises cause at least one general-purpose input/output (GPIO) pin to be in a low state.

19. The method of claim 16, wherein the generating a bus busy condition comprises generate bus busy based on receipt of a START transaction from the one or more other ports.

20. The method of claim 16, wherein the communications are transmitted to or received from a manageability controller.
